(19) United States
(12) Patent Application Publication
(10) Pub. No.: US 2006/0271639 A1
(43) Pub. Date: Nov. 30, 2006

(54) Multipath control device and system

(76) Inventors: Atsuya Kumagai, Kawasaki (JP); Toshihiko Murakami, Fujisawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/178,509

(22) Filed: Jul. 12, 2005

(30) Foreign Application Priority Data
May 20, 2005 (JP) 2005-147799

(51) Int. Cl. G06F 15/16

(52) U.S. Cl. 709/217

(57) ABSTRACT

In a storage device having redundant input/output paths, both a transmission data amount and a reception data amount are smoothed among paths. A storage device predicts not only a transmission data amount to be formed by an output request in a transmission queue but also a reception data amount to be formed by an input request in the transmission queue. The storage device stores a newly occurred output request in a queue having a minimum predicted transmission data amount and stores a newly occurred input request in a queue having a minimum predicted reception data amount. In a storage device having redundant input/output paths, transmission data amounts and reception data amounts can be smoothed among the paths.

### INCORPORATION BY REFERENCE

The present application claims priority from Japanese application JP2005-147799 filed on May 20, 2005, the content of which is hereby incorporated by reference into this application.

### BACKGROUND OF THE INVENTION

The present invention relates to a load distribution method for a computer system, and more particularly to a load distribution method for ports related to storage devices.

In a conventional storage area network (SAN) connecting server computers and storage devices via a dedicated network, multipath technologies have been used in which redundant paths are used for issuing input/output requests. Through involvement of the multipath technologies, it becomes possible to issue an input/output request even a trouble occurs on the path in use, by switching to another path, and to improve an input/output throughput by issuing an input/output request to a plurality of paths in accordance with predetermined rules.

As an example of the algorithm that an apparatus which issues an input/output request to storage devices via a plurality of paths selects the paths, there is a Round Robin algorithm of issuing an input/output request in accordance with an issue order decided before hand for each path. Other examples are a Least Queue Depth algorithm of issuing an input/output request to the path having the minimum number of input/output requests stored in the queue assigned to each path, and a Least Blocks algorithm of issuing a write request to the path having the minimum total sum of write blocks stored in the queue assigned to each path. The Least Blocks algorithm among others are characterized in that the amount of future transmission data is predicted from the number of write request blocks stored in the queue, so that the transmission data amounts on paths can be smoothed. Refer to “iSCSI Management API” by SNIA.

### SUMMARY OF THE INVENTION

All conventional techniques do not predict a reception data amount on each path. A large difference of data amounts may occur among paths, or if a transmission load to be caused by write requests is heavy, a read request cannot be issued although the reception load is low.

In order to solve these issues, an apparatus which issues an input/output request predicts not only a transmission data amount to be formed by write requests in a transmission queue but also a reception data amount to be formed by read requests in the transmission queue. The apparatus which issues an input/output request stores a newly generated write request in the queue having the minimum predicted transmission data amount, and stores a newly generated read request in the queue having the minimum predicted reception data amount.

The apparatus which issues an input/output request predicts the data transmission amount and data reception amount at each port to be formed by a received write request and read request, respectively, and adds the predicted amounts to a data transmission amount and data reception amount at each port predicted to be formed by a write request and read request to be issued from the apparatus.

According to the present invention, the transmission data amounts and reception data amounts on paths can be smoothed at the same time so that a data input/output throughput can be improved. Even if the number of paths is single, a read request can be issued to a storage so as not to be over a data reception ability at the port of the apparatus which issues an input/output request.

### BRIEF DESCRIPTION OF THE DRAWINGS

FIG. 1 is a diagram showing the configuration of a computer system according to a first embodiment of the invention.

FIG. 2 is a diagram showing the contents of a memory of a storage device of the embodiment.

FIG. 3 is a diagram showing examples of a transmission queue.

FIG. 4 is a diagram showing examples of a reception queue.

FIG. 5 is a diagram showing an example of data transmission/reception amount information.

FIG. 6 is a diagram showing an example of command management information.

FIG. 7 is a diagram showing an example of target information.

FIG. 8 is a diagram showing the structure of a memory of a management terminal of the embodiment.

FIG. 9 is a flow chart illustrating a command forwarding process to be executed by a command forwarding program of the embodiment.

FIG. 10 is a flow chart illustrating a process to be executed by an initiator program of the embodiment.

FIG. 11 is a flow chart illustrating another command forwarding process to be executed by the command forwarding program of the embodiment.

FIG. 12 is a flow chart illustrating a process to be executed by a target program of the embodiment.

FIG. 13 is a diagram showing the configuration of a computer system according to a second embodiment.

FIG. 14 is a flow chart illustrating a command reception process to be executed by a target program of the second embodiment.

FIG. 15 is a flow chart illustrating a response transmission process to be executed by the target program of the second embodiment.

FIG. 16 is a flow chart illustrating a command transmission process to be executed by a command issue program according to a third embodiment.

### DESCRIPTION OF THE EMBODIMENTS

Embodiments of the invention will be described with reference to the accompanying drawings.

### First Embodiment

In the first embodiment, the present invention is applied to a computer system in which a storage device transfers a SCSI command received from a host computer to an external storage device.

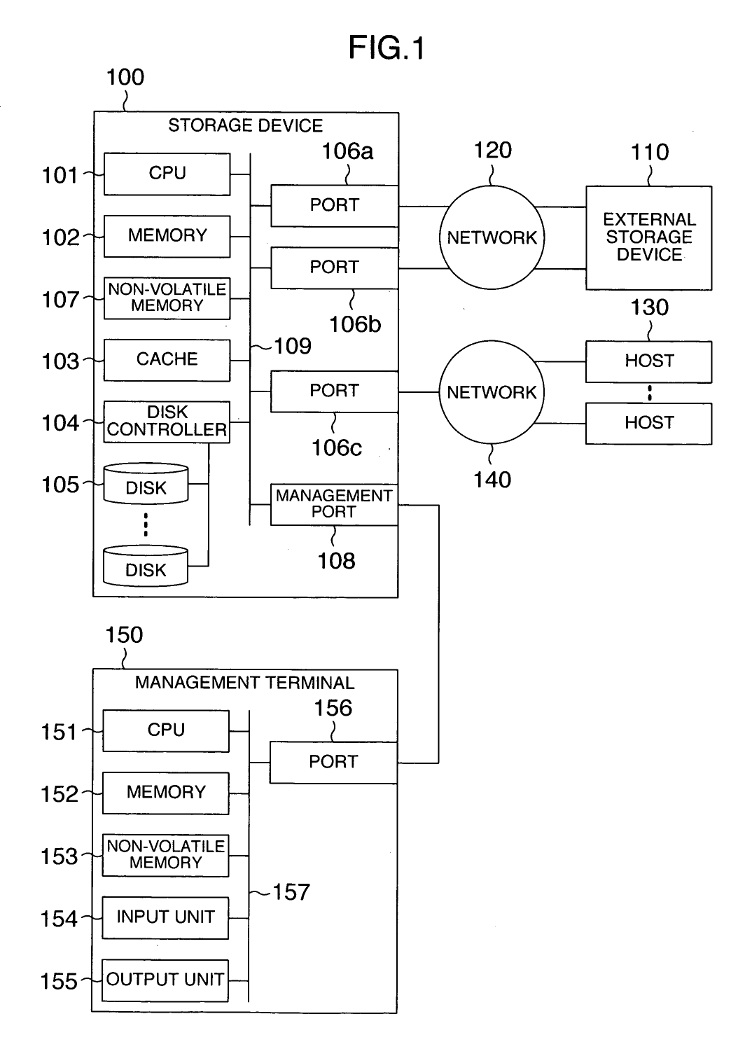

FIG. 1 is a diagram showing the configuration of a computer system of the first embodiment. As shown, the computer system of the first embodiment has a storage device 100, an external storage device 110, a plurality of hosts 130, and a management terminal 150. The storage device 100 and external storage device 110 are interconnected via a network 120 such as the Internet. The storage device 100 and a plurality of hosts 130 are connected via a network 140. The storage device 100 is connected to the management terminal 150.

The host 130 is an information processing apparatus (host computer) which executes an application involving data input/output of the storage device 100.

The storage device 100 has a CPU 101, a memory 102, a cache 103 for temporarily storing data to speed up accesses, a disk controller 104, one or more disks 105, ports 106, a management port 108, and a bus 109 interconnecting these devices.

CPU 101 performs various processes to be described later, by executing programs stored in the memory 102. The memory 102 stores programs and data to be described later. The cache 103 temporarily stores write data. The disk controller 104 controls data input/output of the disks 105. The disk controller 104 may perform processes corresponding to Redundant Array of Independent Disks (RAID). The disk 105 stores data read/written by the host 130. A non-volatile memory 107 stores programs and data to be stored into the memory 102 when the storage device 100 is activated.

The ports 106 are mechanisms such as network cards for connecting local area network (LAN) cables to the storage device 100, and execute data transmission/reception processes relative to external devices via the networks 120 and 140. In this embodiment, although the storage device 100 has three ports 106a, 106b and 106c, the storage device 100 may have three or more ports 106. The management port 108 connects the management terminal 150 to the storage device 100.

The storage device 100 has a relay function of transferring an input/output request issued from the host 130 to the external storage device 110 via the network 120 and transferring a response and data received from the external storage device 110 to the host 130. The external storage device 130 has a structure similar to that of the storage device 100, excepting the relay function.

The host 130 has an initiator function of the iSCSI protocol. The storage device 100 has a target function and an initiator function. The external storage device 110 has a target function.

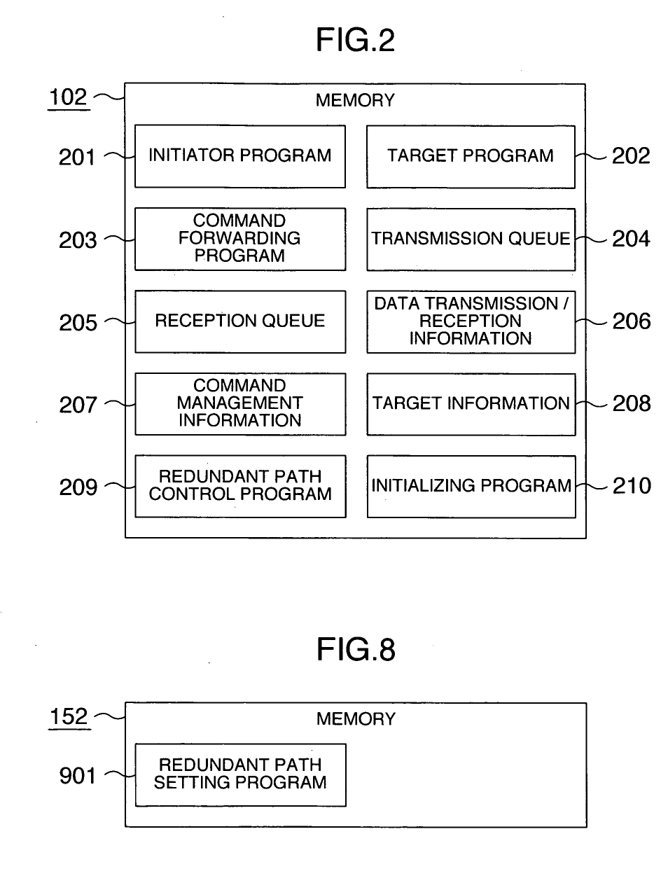

FIG. 2 shows programs and data stored in the memory 102. The memory 102 stores an initiator program 201, a target program 202, a command forwarding program 203, a transmission queue 204, a reception queue 205, data transmission/reception amount information 206, command management information 207, target information 208, a redundant path control program 209 and an initializing program 210.

The initiator program 201 is a program for encapsulating a SCSI command and data into an iSCSI PDU, extracting a SCSI response from an iSCSI PDU, and transmitting/receiving an iSCSI PDU to/from an external iSCSI target, in accordance with the iSCSI protocol. When the port 106 receives an iSCSI PDU including a SCSI response, the initiator program 201 extracts the SCSI response from the iSCSI PDU and stores it in the reception queue 205. The transmission operation of an iSCSI command will be later detailed.

The target program 202 performs mutual exchange between the SCSI command and data and the iSCSI PDU and transmits/receives an iSCSI PDU. When the port 106 receives an iSCSI PDU, the target program 202 extracts the SCSI command from the iSCSI PDU and stores it in the reception queue 205, and further the target program 202 adds an iSCSI header to the SCSI response stored in the top entry of the transmission queue 204 to be described later and transmits it to the host 130. This operation will be detailed later.

The command forwarding program 203 stores the SCSI command stored in the top entry of the reception queue 205 in the transmission queue 204, and stores the SCSI response received by the initiator program 201 in the transmission queue 204. This operation will be detailed later.

The redundant path control program 209 and initializing program 210 will be described later.

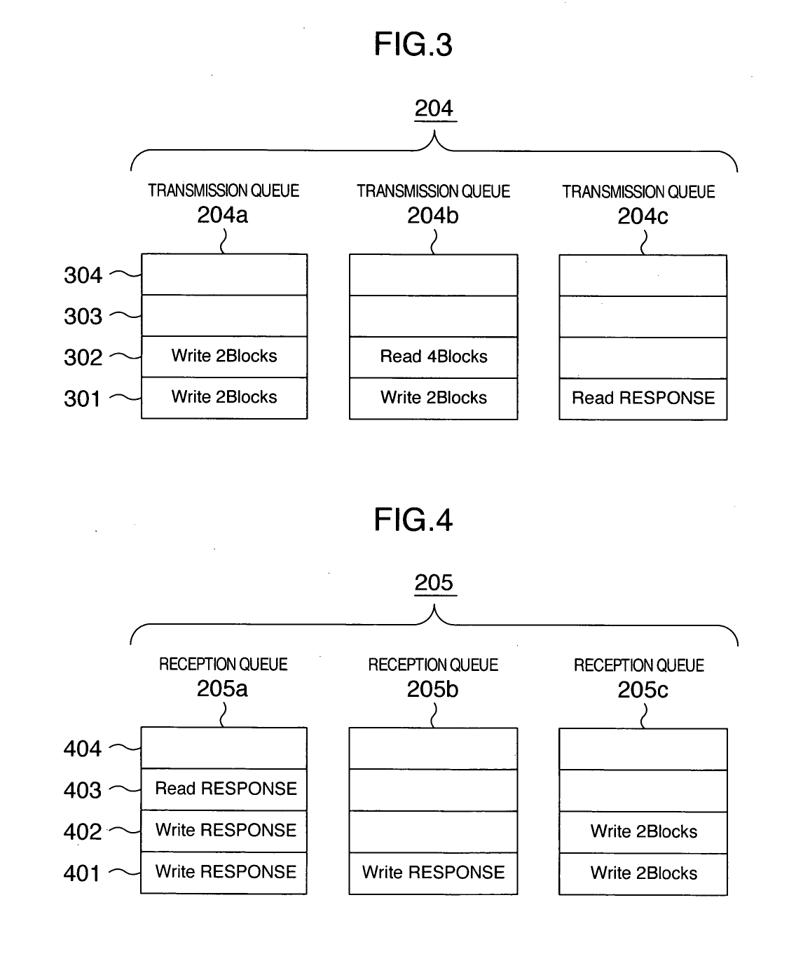

The transmission queue 204 is an area in the memory 102 for storing the SCSI command or SCSI response to be transmitted, and defined at each port. In this embodiment, since the storage device 100 has three ports 106, there are three transmission queues 204a, 204b and 204c corresponding to the ports 106a, 106b and 106c, respectively. FIG. 3 shows examples of the transmission queues 204a, 204b and 204c. In the examples shown in FIG. 3, an area 301 in the transmission queue 204 is the top entry in the memory area, and entries 302, 303, and 304 are defined in this order. The initiator program 201 or target program 202 reads the SCSI command or SCSI response stored in the top entry of the transmission queue 204 and deletes it and the order of the SCSI commands or SCSI responses stored at the second and subsequent entries is raised by one entry up. In the examples shown in FIG. 3, a write request for two blocks is stored in the top entry of the transmission queue 204a. In this embodiment, the block size is set to 512 bytes.

The reception queue 205 is an area in the memory 102 for storing the received SCSI command or SCSI response defined at each port. In this embodiment, similar to the transmission queue, there are three reception queues 205a, 205b and 205c corresponding to the ports 106a, 106b and 106c, respectively. FIG. 4 shows examples of the reception queues 205a, 205b and 205c. Similar to the transmission queues 204, an area 401 in the reception queue 205 is the top entry in the memory area, and entries 402, 403, and 404 are defined in this order. The initiator program 201 or target program 202 reads the SCSI command or SCSI response stored in the top entry of the reception queue 205 and deletes it and the order of the SCSI commands or SCSI responses stored in the second and subsequent entries is raised by one entry up.

In the examples, a Read command and Write commands for the external storage device 110 are stored in the transmission queues 204a and 204b, and the data reception amount of the Read command and the data transmission amounts of the Write commands are shown. A Read response and Write responses received from the external storage device 110 are stored in the reception queues 205a and 205b. The Read response is response data to the Read command. Write commands received from the host 130 are stored in the reception queue 205c, and data reception amounts of the Write commands are shown. A Read response to be transmitted to the host 130 is stored in the transmission queue 204c.

In the queues shown in FIGS. 3 and 4, although the maximum number of SCSI commands or SCSI responses capable of being stored in each queue is 4, it is sufficient that the maximum number of SCSI commands or SCSI responses capable of being stored in each queue is 1 or more.

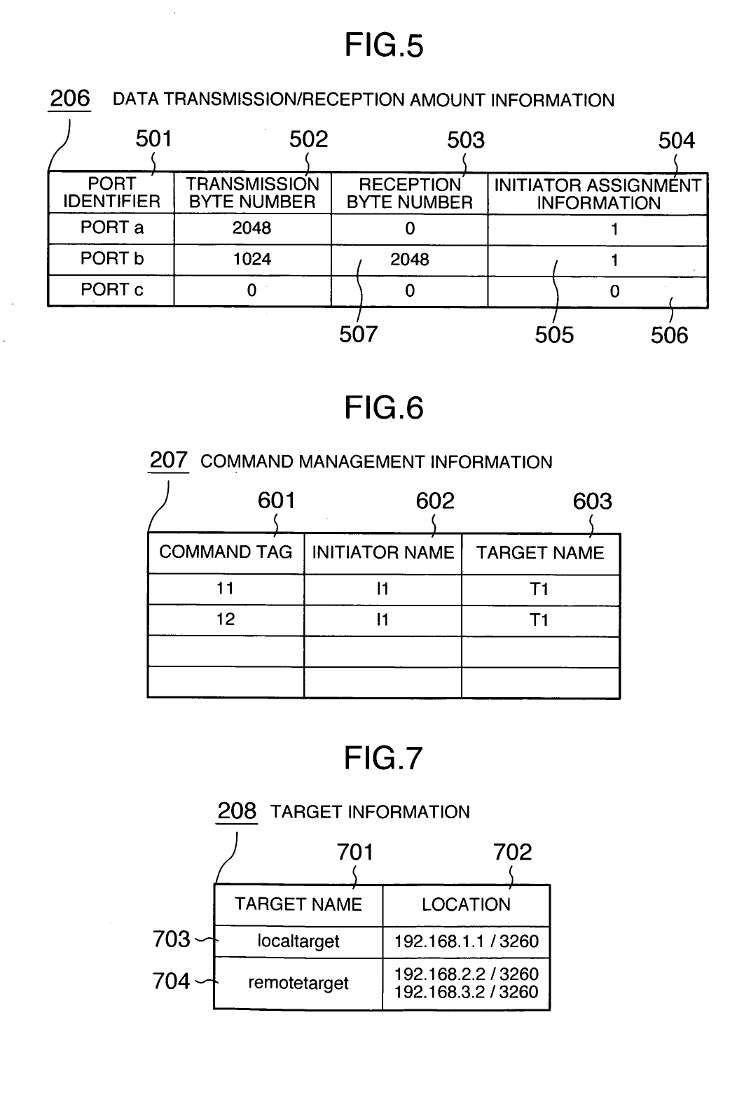

FIG. 5 is a diagram showing examples of the data transmission/reception amount information 206. The data transmission/reception amount information 206 is stored in a table constituted of a combination of information on a port identifier 501, a transmission byte number 502, a reception byte number 503 and initiator assignment information 504. The port identifier 501 is a name for identifying the port. The transmission byte number 502 indicates the number of bytes of transmission data formed by the SCSI Write stored in the queue. The reception byte number 503 indicates the number of bytes of reception data formed by the SCSI Read stored in the queue. The initiator assignment information 504 indicates whether the initiator program 201 is assigned. The value “1” in a cell 505 means that the initiator program 201 can issue an input/output request from the port b. The value “0” in a cell 506 means that the initiator program 201 cannot issue an input/output request from the port c. A cell 507 indicates that the total sum of the requested data amount by the SCSI Read stored in the transmission queue 204b is 2048 bytes.

FIG. 6 is a diagram showing examples of the command management information 207. The command management information 207 is stored in a table constituted of a combination of information on a command tag 601, an initiator name 602 and a target name 603. The command tag 601 is a number for identifying the SCSI command. The initiator name 602 is a name of an initiator issuing the SCSI command. The target name 603 is a name of a target issuing the SCSI command. The examples shown in FIG. 6 show that an initiator I1 issues a SCSI commands 11 and 12 to a target T1. The item corresponding to the SCSI command for which the response is completed is deleted from the command management information 207. An input/output request, in the state that the SCSI command managed by the command management information has already been transmitted and a corresponding SCSI response is not still received, is called an outstanding I/O. An upper limit of the number of outstanding I/Os at the same time instant is preset, and the initiator program 201 controls so that the number of outstanding I/Os at the same instant does not exceed the upper limit. This upper limit is called the maximum number of outstanding I/Os.

FIG. 7 shows examples of the target information 208. The target information 208 is stored in a table constituted of a combination of information on a target name 701 and a location 702. The target name 701 is a name for identifying the target. The location 702 is a location of the target identified by a host name, an IP address, a TCP port number and the like. The examples shown in FIG. 7 show that a target “localtarget” operates at the position identified by an IP address of 192.168.1.1 and a TCP port number 3260, i.e., at the storage device 100 and that a target “remotetarget” existing in the external storage operates at the position identified by an IP address of 192.168.2.2 and a TCP port number 3260 and at the position identified by an IP address of 192.168.3.2 and a TCP port number 3260.

The redundant path control program 209 allows the management terminal 150 to set a load distribution algorithm or the like via the management port 108. The redundant path control program 209 can set the algorithm of the present invention as well as other algorithms such as Round Robin, Least Queue Depth and Least Blocks.

The initializing program 210 initializes the data transmission/reception amount information 206 shown in FIG. 5, the command management information 207 shown in FIG. 6 and the target information 208 shown in FIG. 208. In executing an initializing process for the storage device at the time when a power supply of the storage device 100 is turned on or at other times, CPU 101 executes the initializing program 210 stored in the memory 102 to thereby initialize the data transmission/reception amount information 206, command management information 207 and target information 208.

The management terminal 150 is a personal computer or the like for performing setting works for the storage device 100. The management terminal 150 has a CPU 151, a memory 152, a non-volatile memory 153, an input unit 154, an output unit 155, a port 156 and a bus 157 interconnecting these devices. CPU 151 performs processes to be described layer, by executing programs stored in the memory 152. The memory 152 stores programs and data to be described later. The non-volatile memory 153 stores programs and data to be stored in the memory 152 when the management terminal 150 is activated. The port 156 is a mechanism such as a network card for connecting a local area network (LAN) cable to the management terminal 150, and performs data transmission/reception processes relative to the storage device 100 via a LAN.

FIG. 8 shows a program stored in the memory 152 of the management terminal 150. A redundant path setting program 901 is stored in the memory 152.

The redundant path setting program 901 sets the load distribution algorithm or the like to the storage device 100. The redundant path setting program 901 notifies the redundant path control program 209 of the load distribution algorithm selected from the input unit 154.

Next, description will be made on the operation of the computer system and each process to be executed by the storage device 100.

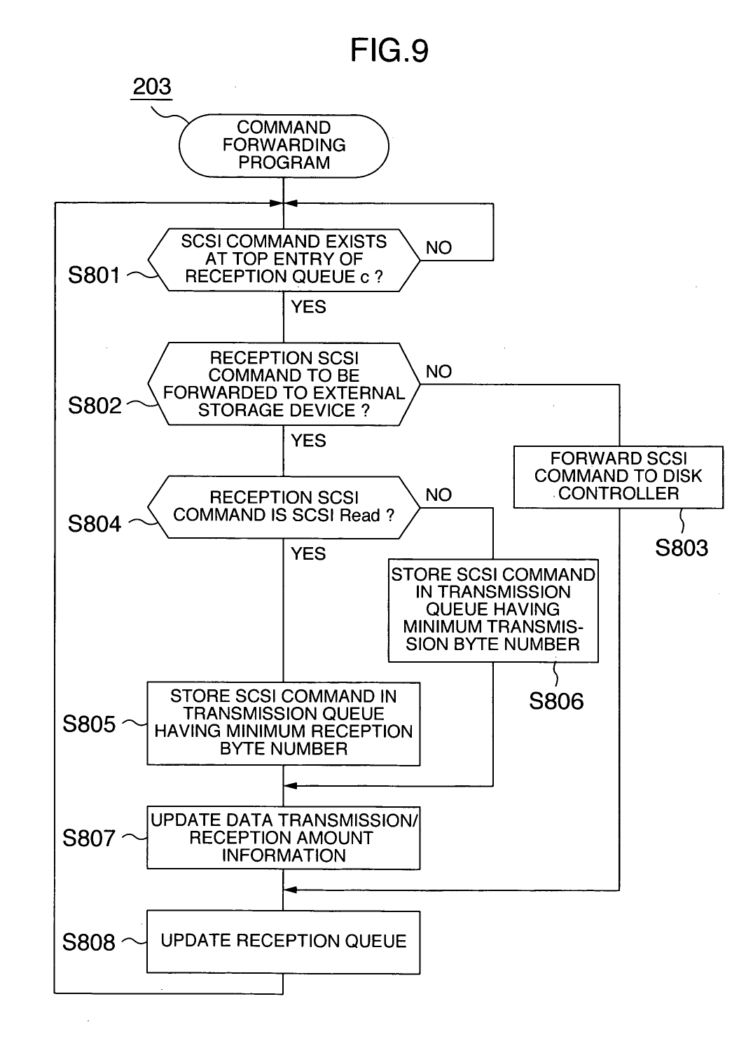

First, with reference to FIG. 9, description will be made on an operation to be performed when the storage device 100 transfers a SCSI command and data received from the host 130 to the external storage device 110.

FIG. 9 is a flow chart illustrating a process to be executed when the command forwarding program 203 transfers a SCSI command. This process starts when CPU 101 executes the command forwarding program 203 stored in the memory 102. If a SCSI command is not stored in the top entry of the reception queue 205c (S801: No), the command forwarding program 203 does not perform the command forwarding process until a SCSI command is stored in the top entry of the reception queues 205c. If a SCSI command is stored in the top entry of the reception queue 205c (S801: Yes), the command forwarding program 203 refers to the target information 208 to judge whether the SCSI command is destined to the external storage device 110 (S802). If the SCSI command is not destined to the external storage device 110 (S802: No), the command forwarding program transfers the SCSI command to the disk controller 104 (S803) to thereafter advance to S808.

If the SCSI command is destined to the external storage device 110 (S802: Yes), it is checked whether the SCSI command is a SCSI Read (S804). If the SCSI command is the SCSI Read (S804: Yes), the command forwarding program 203 refers to the data transmission/reception amount information 206 to store the SCSI Read command in the transmission queue 204 corresponding to the port having the minimum reception byte number 503, among the ports having the initiator assignment information 504 of “1” (S805). If the SCSI command is not the SCSI Read (S804: No), it is either a SCSI Write command or other commands. Therefore, the command forwarding program 203 refers to the data transmission/reception amount information 206 to store the SCSI command in the transmission queue corresponding to the port having the minimum transmission byte number 502, among the ports having the initiator assignment information 504 of “1” (S806).

After the process S805 or S806, the command forwarding program 203 updates the data transmission/reception amount information 206 in accordance with the data transmission/reception amount of the SCSI command stored in the transmission queue 204 (S807). Namely, in the case of the SCSI Read command, a data reception amount to be received by this command is added to the reception byte number 503 at the port corresponding to the transmission queue selected by the data transmission/reception amount information 206. In the case of the SCSI Write command, a data transmission amount to be transmitted by this command is added to the transmission byte number 502 at the port corresponding to the transmission queue selected by the data transmission/reception amount information 206. In the case of the other commands, since the data transmission/reception amount can be neglected, the data transmission/reception amount information 206 will not be updated. The command forwarding program 203 further erases the top entry of the reception queue 205 storing the SCSI command stored in the transmission queue, advances, by one entry toward the top entry side, the storage location of each command stored in the second and subsequent entries (S808).

For example, assuming that the SCSI Read command of 1024 bytes is stored in the top entry of the reception queue 205c, since the reception byte number 503 corresponding to the transmission queue 204a and shown in FIG. 5 is minimum, the command forwarding program 203 stores the SCSI Read command in the transmission queue 204a at Step S805.

For example, assuming that the SCSI Write command of 1024 bytes is stored in the top entry of the reception queue 205c, since the transmission byte number 502 corresponding to the transmission queue 204a and shown in FIG. 5 is minimum, the command forwarding program 203 stores the SCSI Write command in the transmission queue 204b at Step S806.

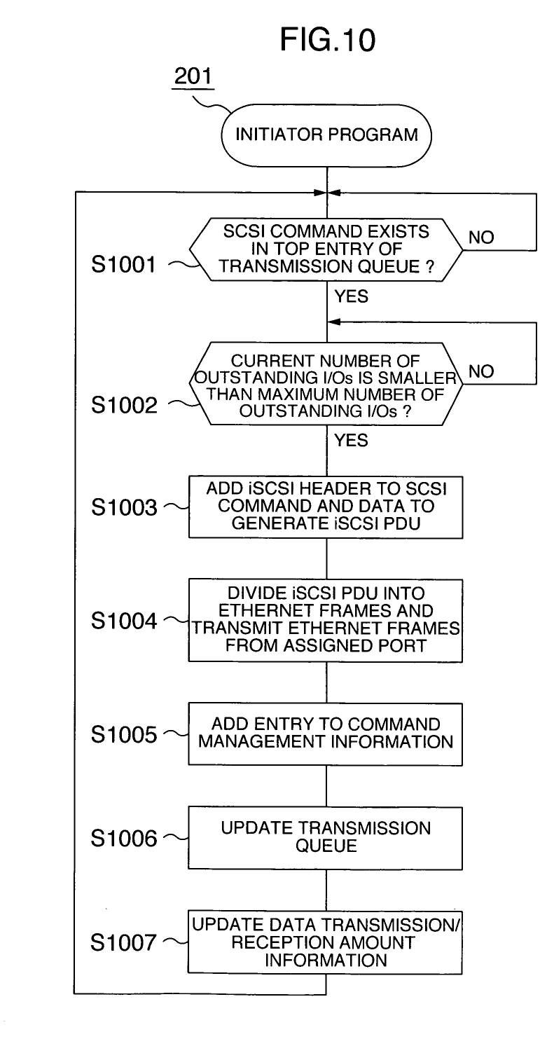

FIG. 10 is a flow chart illustrating a process to be executed when the initiator program 201 transmits a SCSI command. This process starts when CPU 101 executes the initiator program 201 stored in the memory 102. If a SCSI command is stored in the top entry of the transmission queue 204a or 204b (S1001: Yes), the initiator program 201 refers to the command management information 207 to judge whether the current number of outstanding I/Os is smaller than the maximum number of outstanding I/Os (S1002). If a SCSI command is not stored in the top entry of the transmission queue 204 (S1001: No), the initiator program 201 does not perform the command transmission process until a SCSI command is stored in the top entry of the transmission queue 204. If it is judged in the process S1002 that the current number of outstanding I/Os is smaller than the maximum number of outstanding I/Os (S1002: Yes), the initiator program 201 adds a header to the SCSI command and data to generate an iSCSI PDU (S1003), divides the iSCSI PDU into Ethernet frames, transmits the Ethernet frames from the port 106 corresponding to the transmission queue 204 (S1004), and adds an entry of the SCSI command to the command management information 207 (S1005).

If the current number of outstanding I/Os is equal to the maximum number of outstanding I/Os (S1002: No), the initiator program enters a standby state until the current number of outstanding I/Os becomes smaller than the maximum number of outstanding I/Os. In this embodiment, although the maximum number of outstanding I/Os is set to 4, the maximum number of outstanding I/Os is not limited to this unless it exceeds the maximum number of commands capable of being stored in the transmission queue.

After the process S1005, the initiator program 201 deletes the SCSI command transmitted from the transmission queue 204 and the location position of each SCSI command stored in the second and subsequent entries is advanced by one entry up (S1006). Next, the initiator program 201 updates the data transmission/reception amount information 206 (S1007). In the case of a SCSI Write command, the transmitted data amount is subtracted from the transmission byte number 502 in the data transmission/reception amount information 206 corresponding to the port from which the command was transmitted. In the case of the SCSI Read command, the data transmission/reception amount information 206 is not updated.

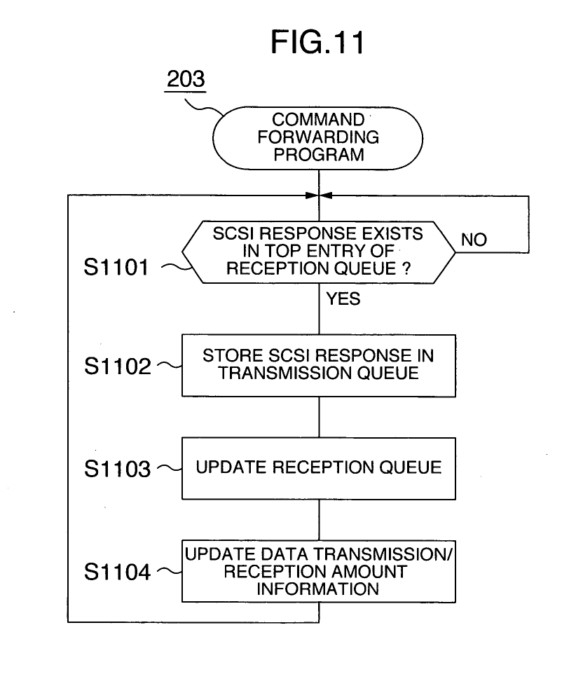

Next, with reference to FIG. 11, description will be made on an operation to be performed when the storage device 100 transfers the SCSI response and Read data received from the external storage device 110 to the host 130.

FIG. 11 is a flow chart illustrating a process to be executed when the command forwarding program 203 transfers a SCSI response and data. This process starts when CPU 101 executes the command forwarding program 203 stored in the memory 102. If a SCSI response and data are stored in the top entry of the reception queue 205a or 205b (S1101: Yes), the command forwarding program 203 stores the SCSI response in the transmission queue 204 corresponding to the port whereat the corresponding SCSI command was received (S1102). The command forwarding program 203 further deletes the SCSI response stored in the reception queue 205a or 205b from which the SCSI response was extracted, and advances, by one entry toward the top entry, the location position of each SCSI command in the second and subsequent entries (S1103). Next, the command forwarding program 203 updates the data transmission/reception amount information 206 (S1104). In the case of a Read response, the received data amount is subtracted from the reception byte number 503 in the data transmission/reception amount information 206 corresponding to the port at which the response was received. In the case of a Write response, the data transmission/reception amount information 206 is not updated.

If a SCSI response is not stored in the top entry of the reception queue 205 (S1101: No), the command forwarding program 203 does not perform the response transfer process until a SCSI response is stored in the top entry of the transmission queue 204.

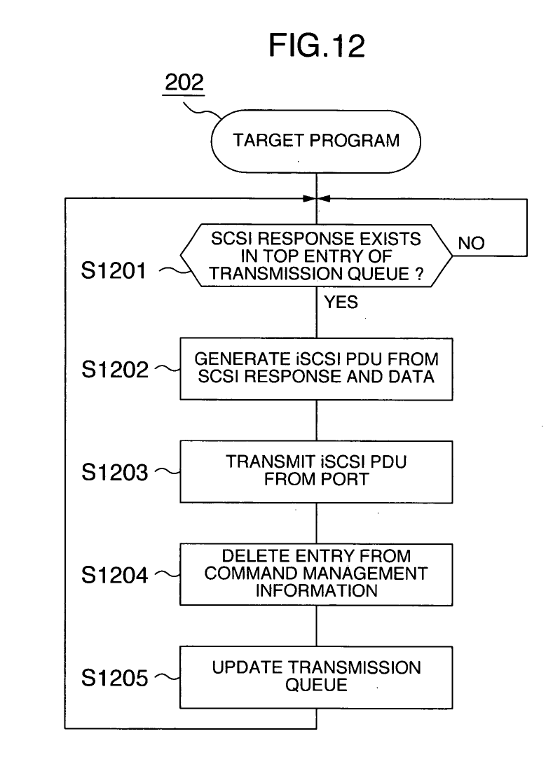

FIG. 12 is a flow chart illustrating a process to be executed when the target program 202 transmits a SCSI response and Read data. This process starts when CPU 101 executes the target program 202 stored in the memory 102. If a SCSI response and data are stored in the top entry of the transmission queue 204 (S1201: Yes), the target program 202 generates an iSCSI PDU from the SCSI response and data (S1202), transmits the generated iSCSI PDU from the port (S1203) and deletes the entry of the SCSI command corresponding to the SCSI response from the command management information 207 (S1204). Next, the target program 202 deletes the SCSI response transmitted from the transmission queue 204, and advances by one entry toward the top entry the storage location of each SCSI response stored in the second and subsequent entries (S1205).

If a SCSI response is not stored in the top entry of the transmission queue 204 (S1201: No), the target program 202 does not perform the response transmission process until a SCSI command is stored in the top entry of the transmission queue 204.

According to the first embodiment, it is possible to smooth transmission/reception data amounts at ports per unit time to be transmitted/received by the iSCSI initiator operating in the storage device 100.

In the description of the first embodiment, the storage device 100 transmits/receives the SCSI command and SCSI response to/from the host 130 via a single port 106c. The present invention is also applicable to the case in which the storage device 100 transmits/receives the SCSI command and SCSI response to/from the host 130 via two or more ports. This will be detailed in the third embodiment.

### Second Embodiment

In the description of the first embodiment, the storage device 100 uses the port 106 only for transmitting a SCSI command and receiving a SCSI response. In other words, the ports 106a and 106b are used only by an initiator and do not receive a SCSI command, whereas the port 106c is used only for a target and does not transmit a SCSI command, limiting the role of each port. In the first embodiment, therefore, a load distribution can be conducted by considering only the load of the transmission port. In the second embodiment, the storage device 100 uses the port 106 for transmission/reception of a SCSI command and a SCSI response.

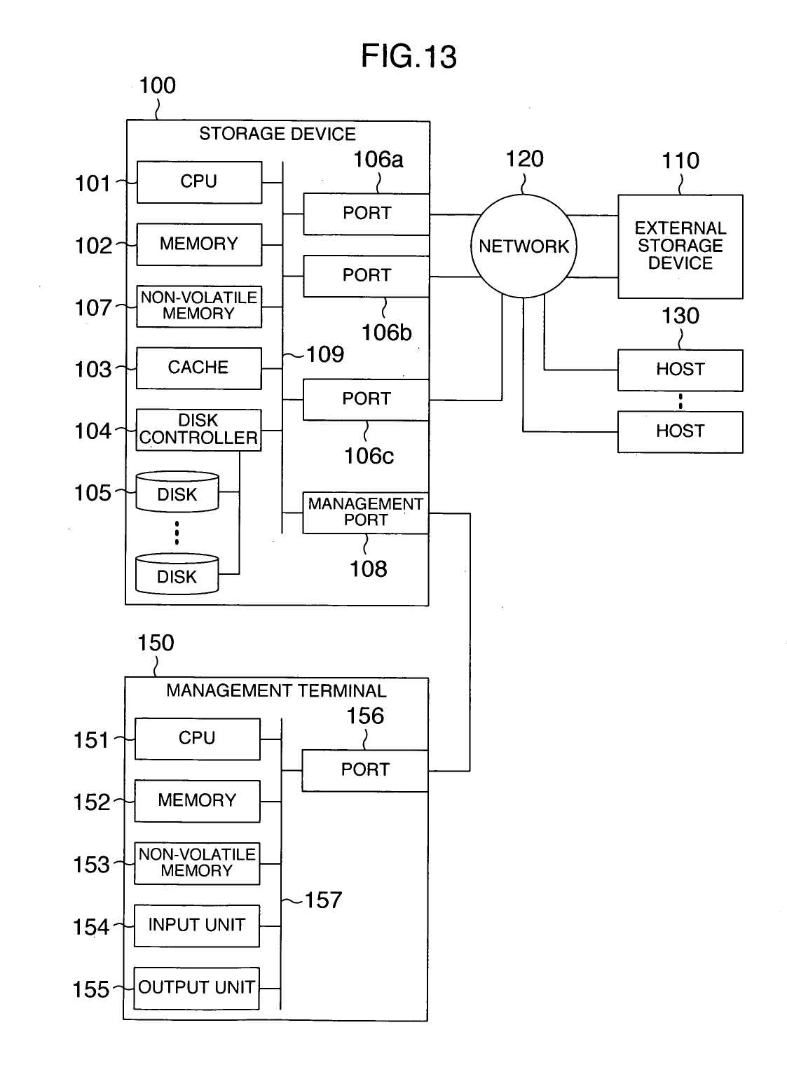

FIG. 13 is a diagram showing the configuration of a second embodiment of a computer system. The devices and programs constituting this system are similar to those of the first embodiment, excepting that the same network 120 interconnecting the storage device 100 and hosts 130 is used for interconnecting the storage device 100 and external storage device 110 and that the operation of the target program 202 is modified. In the second embodiment, the role of each port 106 is not limited as in the case of the first embodiment. In the second embodiment, therefore, the load distribution among the ports is conducted by considering the loads of both the transmission and reception ports.

In the following, description will be made on the operation of the computer system and a modified process in the storage device 100.

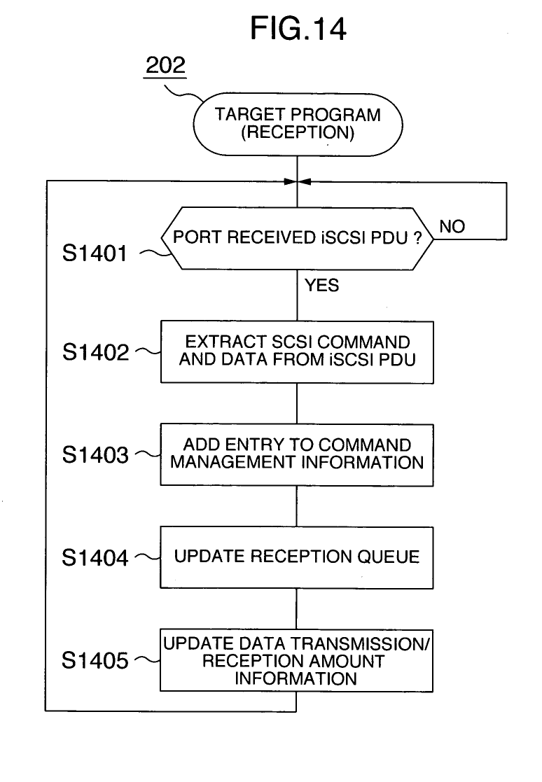

FIG. 14 is a flow chart illustrating a process to be executed when the target program 202 receives an iSCSI PDU. This process starts when CPU 101 executes the target program 202 stored in the memory 102. As the port 106 receives an iSCSI PDU (S1401: Yes), the target program 202 extracts an SCSI command and data from the iSCSI PDU (S1402). The target program 202 further adds an entry of the SCSI command to the command management information 207 (S1403) and adds the SCSI command to the bottom entry of the reception queue 205 (S1404). Then, the target program 202 updates the data transmission/reception amount information 206 (S1405). If the received SCSI command is a SCSI Read command, a data transmission amount to be transmitted by the command is added to the transmission byte number 502 in the data transmission/reception amount information 206 corresponding to the port received the command. If the received SCSI command is a SCSI Write command, a data reception amount to be received by the command is added to the reception byte number 503 in the data transmission/reception amount information 206 corresponding to the port received the command.

For example, if the port 106a receives a SCSI Read command requesting data of 1024 bytes, the value “2048” of the reception byte number 502 is rewritten to “3072”.

The target program 202 does not perform the PDU transmission process until an iSCSI PDU is received.

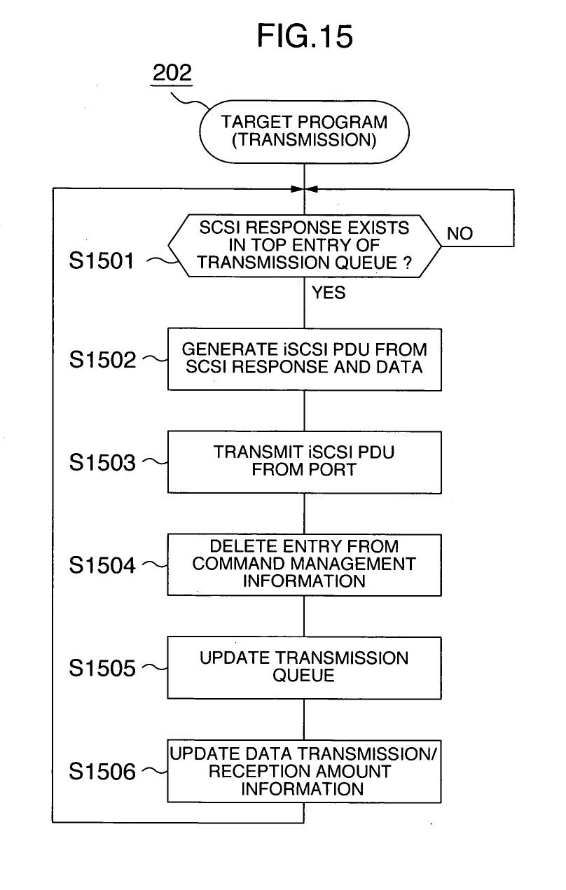

FIG. 15 is a flow chart illustrating a process to be executed when the target program 202 transmits a SCSI response and Read data. This process starts when CPU 101 executes the target program 202 stored in the memory 102. If a SCSI response is stored in the top entry of the transmission queue 204 (S1501 Yes), the target program 202 generates an iSCSI PDU from the SCSI response and data (S1502), transmits the generated iSCSI PDU from the corresponding port (S1503), and deletes the entry of the SCSI command corresponding to the SCSI response from the command management information 207 (S1504). The target program 202 further deletes the SCSI response stored in the top entry of the transmission queue 204 and advances by one entry toward the top entry the storage location of each SCSI response stored in the second and subsequent entries (S1505). Then, the target program 202 updates the data transmission/reception amount information 206 in accordance with the contents of the SCSI command stored in the transmission queue 204 (S1506). Namely, in the case of a Read response, a data transmission amount by the command is subtracted from the transmission byte number 502 in the data transmission/reception amount information 206 corresponding to the port. In the case of a Write response, a data reception amount by the command is subtracted from the reception byte number 503 in the data transmission/reception amount information 206 corresponding to the port.

If a SCSI response is not stored in the top entry of the transmission queue 204 (S1501: No), the target program 202 does not perform the response transmission process until a SCSI response is stored in the top entry of the transmission queue.

According to the second embodiment, it is possible to smooth transmission/reception data amounts at ports per unit time to be transmitted/received by an iSCSI initiator and an iSCSI target operating in the storage device 100.

### Third Embodiment

The third embodiment is characterized in a port load distribution control on the side of a host 130 when the storage device 100 transmits/receives a SCSI command and a SCSI response to/from the host via two or more ports. The host 130 is provided with a command issue program 211 in place of the command forwarding program 203. The initiator program 201 performs the process shown in FIG. 10, excluding S1002 and S1005. There is no target program 202. Similar to the first embodiment, there exist the transmission queue 204, reception queue 205 and data transmission/reception amount information 206.

As the structure on the storage device 100 side of the third embodiment, the programs and control information constituting the second embodiment are used without modification.

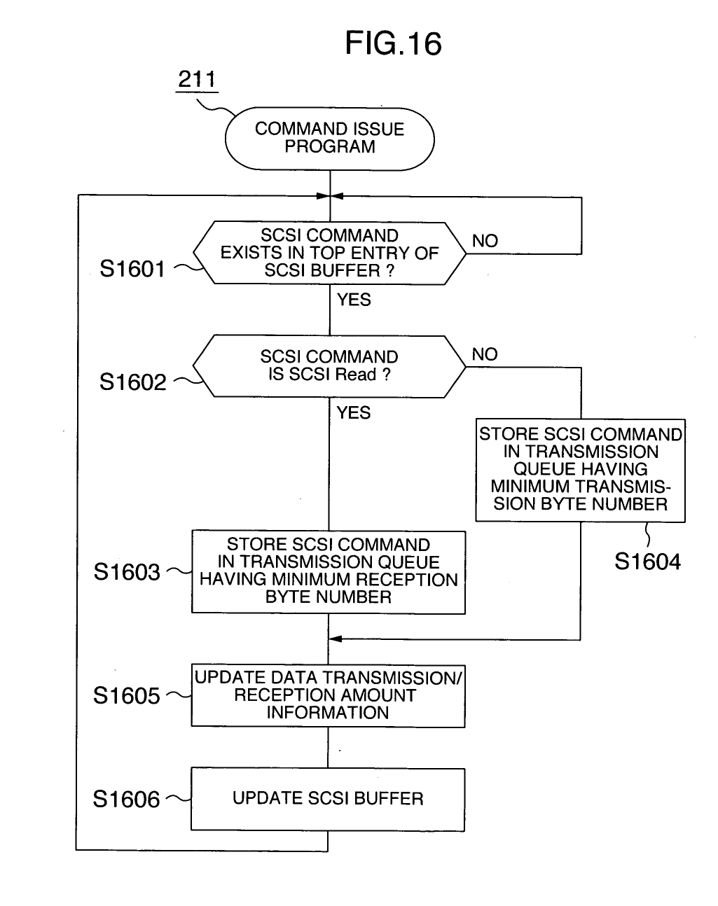

FIG. 16 is a flow chart illustrating a process to be executed when the command issue program 211 issues a SCSI command. This process starts when the host 130 executes the command issue program 211 stored in a memory. If a SCSI command is not stored in the top entry of a SCSI buffer (S1601: No), the command issue program 211 does not perform the command transmission process until a SCSI command is stored in the top entry of the SCSI buffer. If a SCSI command is stored in the top entry of a SCSI buffer (S1601: Yes), the command issue program 211 judges whether the SCSI command is a SCSI Read (S1602). If the SCSI command is a SCSI Read (S1602: Yes), the command issue program 211 refers to the data transmission/reception amount information 206 and stores the SCSI Read command in the transmission queue 204 corresponding to the port having the minimum reception byte number 503 among the ports having the initiator assignment information 504 of “1” (S1603). If the SCSI command is not a SCSI Read (S1602: No), the command issue program 211 refers to the data transmission/reception amount information 206 and stores the SCSI command in the transmission queue 204 corresponding to the port having the minimum transmission byte number 502 among the ports having the initiator assignment information 504 of “1” (S1604). After the process S1603 or S1604, the command issue program 211 updates the data transmission/reception amount information 206 in accordance with the contents of the SCSI command stored in the transmission queue 204 (S1605). The process S1605 is similar to the process S807. The command issue program 211 further deletes the top entry of the SCSI buffer storing the transferred SCSI command, and advances by one entry toward the top entry the storage location of each SCSI command stored in the second and subsequent entries (S1606).

If a SCSI response exists in the top entry of the reception queue 205, the command issue program 211 executes the processes S1103 and S1104.

In the description of the above embodiments, SAN is configured by an IP network, and a SCSI command and data are transmitted/received in accordance with the iSCSI protocol. The present invention is not limited thereto, but the present invention may adopt other protocols such as a Fibre Channel if the protocol can perform data input/output relative to the storage device.

1. A storage device connected to another storage device via a network and having a plurality of transmission queues for temporarily storeing an input/output request to be transmitted to said other storage device, the storage device comprising:
selecting means for selecting, if said input/output request is an input request, a transmission queue having a minimum data reception amount to be formed by an input/output request or requests already stored in the transmission queue, and if said input/output request is an output request, a transmission queue having a minimum data transmission amount to be formed by an input/output request or requests already stored in the transmission queue; and
means for storeing said input/output request to be transmitted in said selected transmission queue.

2. The storage device according to claim 1, wherein said transmission queue is provided in correspondence with a port for connecting said storage device to said other storage device.

3. The storage device according to claim 2, further comprising a table, provided in a memory of the storage device, for storing said data transmission amount and said data reception amount at each of said ports.

4. A storage device connected to another storage device and a host computer via a network and having a plurality of transmission queues for temporarily storeing an input/output request to be transmitted to said other storage device, and a reception queue paired with each of said transmission queues for temporarily storeing an input/output request received from said host computer, the storage device comprising:
selecting means for selecting a transmission queue having a minimum total sum of a data transmission amount to be formed by an input request or requests stored in said reception queue and a data transmission amount to be formed by an output request or requests stored in said transmission queue; and
means for storeing said input/output request to be transmitted in said selected transmission queue.

5. The storage device according to claim 4, wherein said transmission queue is provided in correspondence with a port for connecting said storage device to said other storage device.

6. The storage device according to claim 5, further comprising a table, provided in a memory of the storage device, for storing said data transmission amount and said data reception amount at each of said ports.

7. A storage device comprising:
a CPU and a memory:
a plurality of ports, connected to an external storage device via a network, for transmitting/receiving an input/output command and a response;
a port, connected to a host computer via the network, for transmitting/receiving an input/output command and a response;
a plurality of transmission queues, provided in correspondence with said ports and in said memory, for temporarily storeing an input/output command to be transmitted to said external storage device;
a plurality of reception queues, provided in correspondence with said ports and in said memory, for temporarily storeing an input/output command received from said host computer;
data transmission/reception information provided in said memory and being representative of a data transmission amount and a data reception amount of data to be formed by said input/output command or commands stored in said transmission queue, for each of said ports; and
a command forwarding program, stored in said memory to be executed by said CPU, for selecting, if said input/output command to be stored in said reception queue is an input command, a transmission queue having a minimum data reception, and if said input/output command is an output command, a transmission queue having a minimum data transmission, forwarding said input/output command from said reception queue to said selected transmission queue, and increasing said data reception amount or said data transmission amount corresponding to said selected transmission queue by a data amount increased by said input/output command,
wherein said data transmission amount is reduced by a data amount increased if said output command is transmitted from said selected transmission queue via said port, and said data reception amount is reduced by a data amount increased if a response to said input command is received.

8. The storage device according to claim 7, further comprising command management information, provided in said memory, being representative of an identifier of a pending input/output command, wherein if said input/output command is transmitted from said transmission queue via said port, the storage device registers said input/output command in said command management information, and if a response to said input/output command is received, the storage device deletes the identifier of said input/output command.

9. A host computer connected to a storage device via a network and having a plurality of transmission queues for temporarily storeing an input/output request to be transmitted to said storage device, the storage device comprising:
selecting means for selecting, if said input/output request is an input request, a transmission queue having a minimum data reception amount to be formed by an input/output request or requests already stored in the transmission queue, and if said input/output request is an output request, a transmission queue having a minimum data transmission amount to be formed by an input/output request or requests already stored in the transmission queue; and
means for storeing said input/output request to be transmitted in said selected transmission queue.

10. The host computer according to claim 9, wherein said transmission queue is provided in correspondence with a port for connecting said host computer to said storage device.

11. The host computer according to claim 10, further comprising a table, provided in a memory of the host computer, for storing said data transmission amount and said data reception amount at each of said ports.

12. A storage device comprising:
a CPU and a memory:
a plurality of ports, connected to a host computer and an external storage device via a network, for transmitting/receiving an input/output command and a response;
a plurality of transmission queues, provided in correspondence with said ports and in said memory, for temporarily storeing an input/output command to be transmitted to said external storage device;
a plurality of reception queues, provided in correspondence with said ports and in said memory, for temporarily storeing an input/output command received from said host computer;
data transmission/reception information provided in said memory and being representative of a data transmission amount and a data reception amount of data to be formed by said input/output command or commands stored in said transmission queue, for each of said ports; and
a command forwarding program, stored in said memory to be executed by said CPU, for selecting, if said input/output command to be stored in said reception queue is an input command, a transmission queue having a minimum data reception, and if said input/output command is an output command, a transmission queue having a minimum data transmission, forwarding said input/output command from said reception queue to said selected transmission queue, and increasing said data reception amount or said data transmission amount corresponding to said selected transmission queue by a data amount increased by said input/output command,
wherein said data transmission amount is reduced by a data amount increased when said output command is transmitted from said selected transmission queue via said port, and said data reception amount is reduced by a data amount increased when a response corresponding to said input command is received.

13. The storage device according to claim 12, further comprising command management information, provided in said memory, being representative of an identifier of a pending input/output command, wherein if said input/output command is transmitted from said transmission queue via said port, the storage device registers said input/output command in said command management information, and if a response to said input/output command is received, the storage device deletes the identifier of said input/output command.

14. A computer system comprising:
a host computer, connected to a storage device via a network, for transmitting an input/output request to said storage device, said storage device connected via the network to another storage device and having a plurality of transmission queues for temporarily storeing an input/output request to be transmitted to said other storage device, said storage device comprising:
selecting means for selecting, if said input/output request received in said reception queue is an input request, a transmission queue having a minimum data reception amount to be formed by an input/output request or requests already stored in the transmission queue, and if said input/output request received in said reception queue is an output request, a transmission queue having a minimum data transmission amount to be formed by an input/output request or requests already stored in the transmission queue; and
means for storeing said input/output request to be transmitted in said selected transmission queue.

15. The computer system according to claim 14, wherein said transmission queue is provided in correspondence with a port for connecting said storage device to said other storage device, and said reception queue is provided in correspondence with a port for connecting said storage device to said host computer.
